(19) United States
(12) Patent Application Publication
(10) Pub. No.: US 2008/0109836 A1
(43) Pub. Date: May 8, 2008

(54) OPTICAL DISK APPARATUS

(76) Inventor: Sojiro Kirihara, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/840,255

(22) Filed: Aug. 17, 2007

(30) Foreign Application Priority Data
Nov. 8, 2006 (JP) 2006-303103

(51) Int. Cl. G11B 17/028

(52) U.S. Cl. 720/697

(57) ABSTRACT

An optical disc apparatus includes a base for supporting a unit mechanism portion as well as a motor fixed plate to which a spindle motor is attached. In the optical disc apparatus, a portion of the outside of an outer diameter of the spindle motor is brought into contact with an outer edge of the base so that the portion thereof is supported by the base.

### CLAIM OF PRIORITY

The present application claims priority from Japanese application serial No. P2006-303103, filed on Nov. 8, 2006, the content of which is hereby incorporated by reference into this application.

### BACKGROUND OF THE INVENTION

1. Technical Field of the Invention

The present invention relates to an optical disc apparatus for recording or reproducing information to or from an optical disc, and more particularly to a support structure of a spindle motor for rotating the optical disc.

2. Description of the Related Art

In a thin optical disc apparatus of unit mechanism type, for example, as shown in FIGS. 4 and 5, a spindle motor 2 is attached to a planar motor fixed plate 15′ and the motor fixed plate 15′ is fixed to a unit mechanism deck 5a′ of a unit mechanism portion 5′ at three positions 161′, 162′, 163′ by means of screws and the like, respectively. The unit mechanism portion 5′ is arranged to be displaceable relative to a chassis 4 which is an apparatus base provided in a bottom case 8, within a plane substantially perpendicular to a plane of the chassis 4. Assuming that the line C-C′ is a line through a rotation center c of the spindle motor 2 in parallel to the moving direction of an optical pickup 3 and that the line D-D′ is a line through the rotation center c of the spindle motor 2 in perpendicular to the moving direction of the optical pickup 3, the two positions 161′, 162′ of the three positions to which the motor fixed plate 15′ is fixed are provided on the opposite side of the optical pickup 3 relative to the line D-D′ as well as provided on the opposite side of the other position 163′ relative to the line C-C′. The position 163′ is provided close to the line D-D′. Incidentally in FIG. 5, c is the rotation center of the spindle motor 2, θ₁′ is an angle between a line through the position 161′ and the line D-D′, θ₂′ is an angle between a line through the position 162′ and the line D-D′, and θ₃′ is an angle between a line through the position 163′ and the line D-D′.

Examples of technologies related to the present invention include those described in the following Patent References: JP-A No. 293647/2005, JP-A No. 147000/2006, and JP-A No. 4861/2005.

### SUMMARY OF THE INVENTION

Along with the recent diversification of the environment in which optical disc apparatus is used, there has been a demand for high impact resistance. Of the related technologies described above, in the configuration shown in FIGS. 4 and 5, for example when an impact force F is applied to a plane of the chassis 4 or bottom case 8 in a vertical direction (−Z axis direction), a moment M′ acts on the motor fixed plate 15′ as shown in FIG. 6. Due to the moment M′, a portion between the positions 162′ and 163′ to which the motor fixed plate 15′ is fixed, is displaced by an angle ψ together with the spindle motor 2 relative to the Y axis direction. Then the motor fixed plate 15′ is in a state indicated by the dotted line. As a result, the rotation center axis c of the spindle motor 2 is also displaced to a position of a rotation center axis c′. Such displacements of the position and posture of the spindle motor 2 can change the positional relationship between an optical disc placed on the spindle motor 2 and the optical pickup 3, thereby causing problems such as contact and defocusing of an objective lens 3a relative to a surface of the optical disc.

Further in the optical disc apparatuses described in JP-A No. 293647/2005 and JP-A No. 147000/2006 as well as in the optical disc apparatus described in JP-A No. 4861/2005, the spindle motor is supported by the same structure as described above in FIGS. 4 and 5. Thus the same position and posture displacements as those described above in FIG. 6 would occur in the spindle motor.

In view of the circumstances of the related technologies described above, it is desirable for an optical disc apparatus to be able to support a spindle motor with an improved impact resistance by a simple configuration.

The present invention is a technology capable of solving the above problems and achieving the above object.

That is, according to the present invention, in an optical disc apparatus including a base (second base) for supporting a unit mechanism portion and a motor fixed plate to which a spindle motor is attached, a portion of the outside of an outer diameter of the spindle motor is brought into contact with an outer edge portion of the base so that the portion thereof is supported by the base.

### BRIEF DESCRIPTION OF THE DRAWINGS

FIG. 1 is a view showing an example of the general configuration of an optical disc apparatus as an embodiment of the present invention;

FIG. 2 is a reverse view of a unit mechanism portion in the configuration of FIG. 1;

FIG. 3 is a view illustrating a motor fixed plate in the unit mechanism portion of FIG. 2;

FIG. 4 is a view illustrating a unit mechanism portion in an optical disc apparatus used in the past;

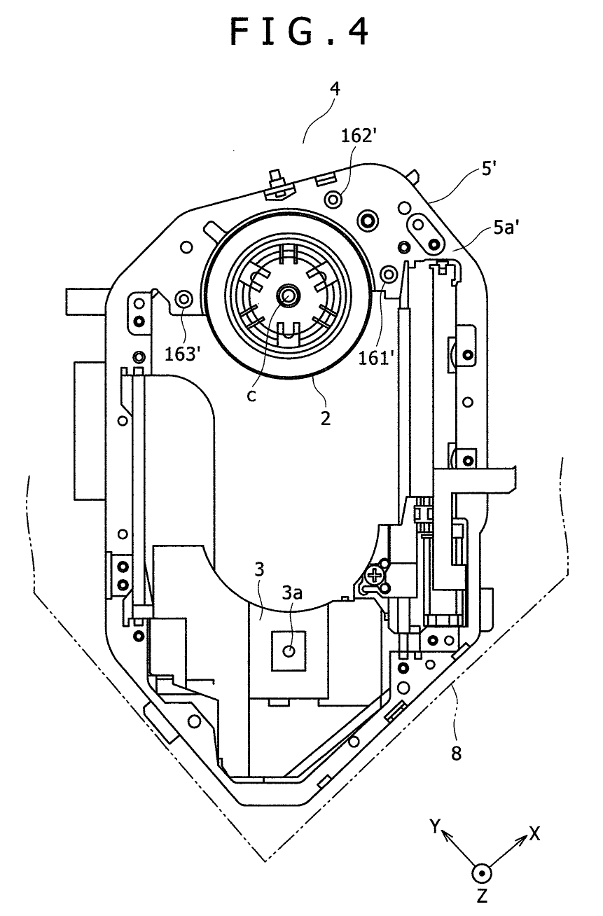

FIG. 5 is a reverse view of the configuration of FIG. 4; and

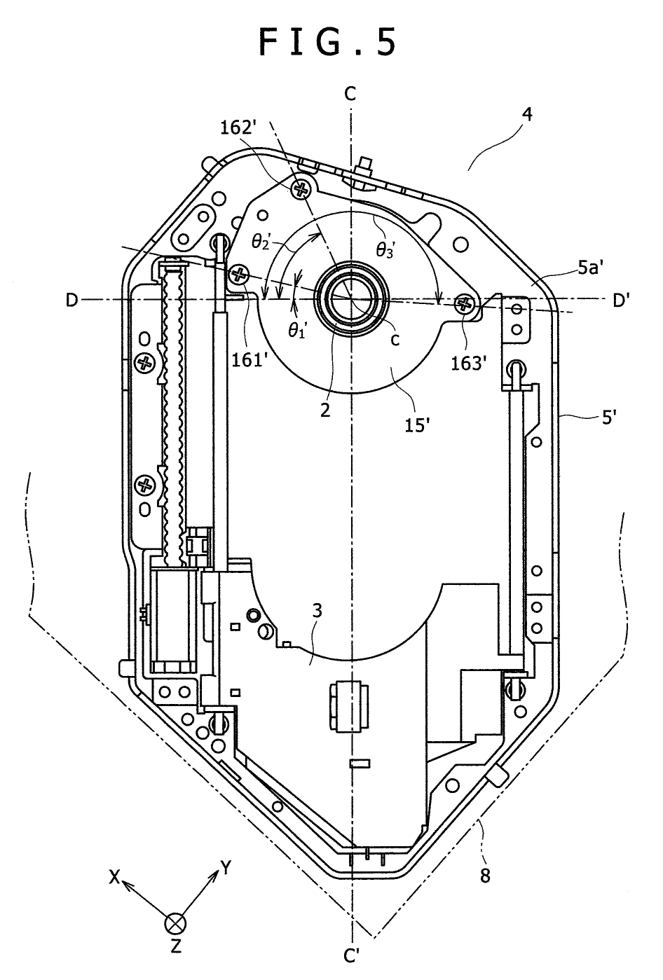

FIG. 6 is a view illustrating displacements of the motor fixed plate in the configuration of FIG. 5

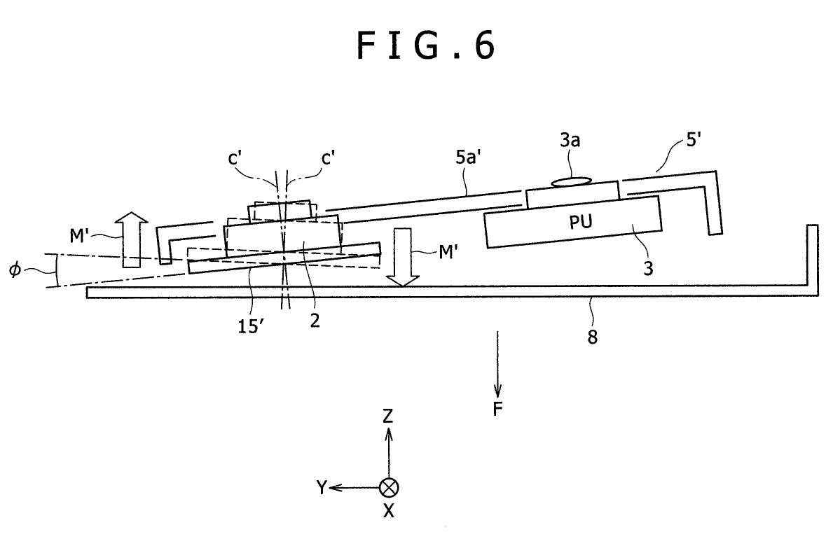

### DETAILED DESCRIPTION OF THE PREFERRED EMBODIMENT

Hereafter an embodiment of the present invention will be described with reference to accompanying drawings.

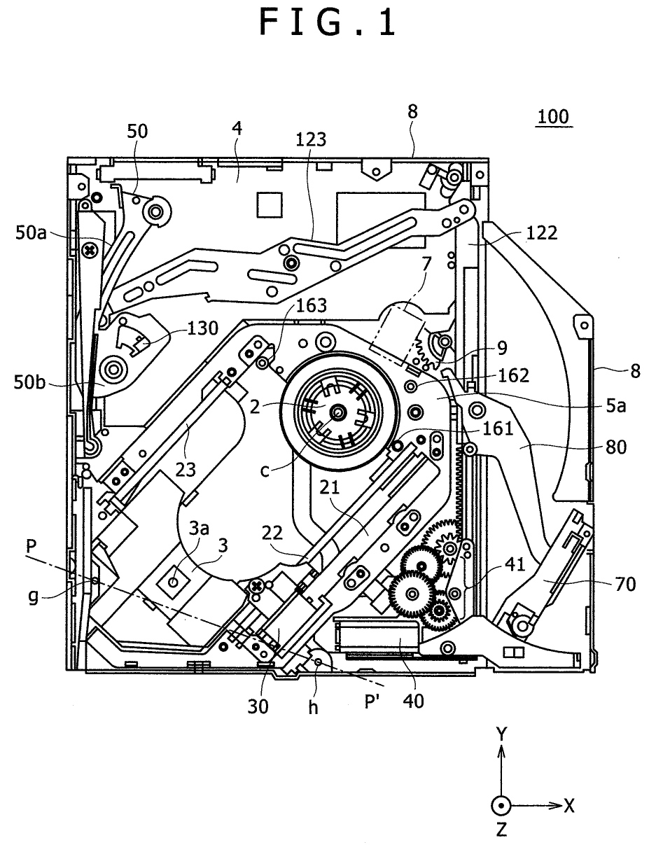

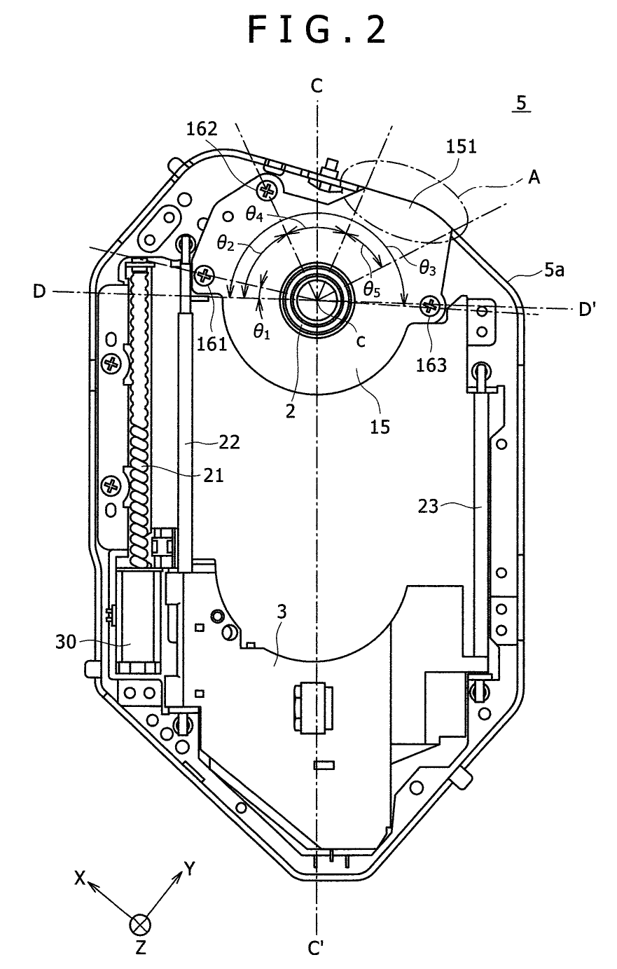

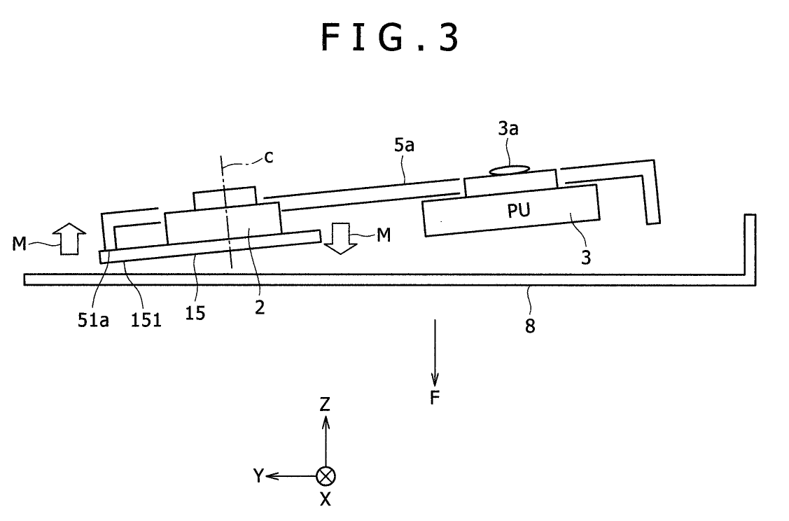

FIGS. 1 to 3 are views illustrating an embodiment of the present invention. FIG. 1 is a view showing an example of the general configuration of a slot-in type optical disc apparatus as an embodiment of the present invention. FIG. 2 is a rear view of a unit mechanism portion in the configuration of FIG. 1. FIG. 3 is a view illustrating a motor fixed plate in the unit mechanism portion of FIG. 2. In the configuration of FIGS. 1 to 3, like components are designated by like reference numerals and the same coordinate axes are used.

FIG. 1 is a view showing an example of the configuration of the front side (Z axis direction side, namely, the side on which a disc is placed) of an optical disc apparatus as an embodiment of the present invention.

In FIG. 1, reference numeral 100 denotes an optical disc apparatus. Numeral 2 denotes a spindle motor (which is assumed to include a turntable) for rotating and driving an optical disc (not shown). Numeral 3 denotes an optical pickup. Numeral 3a denotes an objective lens. Numeral 4 denotes a chassis as a first base which is an apparatus base. Numeral 5 denotes a unit mechanism portion in which the spindle motor 2 and the optical pick up 3 are provided. Numeral 5a denotes a unit mechanism deck member as a second base rotatable and displaceable about a fulcrum relative to the chassis 4, which is a support base of the unit mechanism portion 5 in which the spindle motor 2 and the optical pickup 3 are provided. Numeral 7 denotes a raising/lowering mechanism portion for rotating the unit mechanism deck member 5a about the fulcrum and vertically displacing the unit mechanism deck member 5a relative to the chassis 4. Numeral 8 denotes a bottom case provided outside the chassis 4 to cover the back side of the optical disc apparatus 100. Numeral 9 denotes a drive gear for giving a driving force to the raising/lower mechanism portion 7. Numeral 21 denotes a lead screw member provided with a screw on a surface thereof to move the optical pickup 3 through rotation of the screw in a substantially radial direction of the optical disc (not shown). Numerals 22, 23 denote guide members for guiding movement of the optical pickup 3. Numeral 30 denotes a feed motor for rotating and driving the lead screw member 21. Numeral 40 denotes a loading motor for generating a driving force for moving the optical disc to be loaded or unloaded. Numeral 41 denotes a transmission gear array for transmitting the driving force from the loading motor 40 to the load side. Numeral 50 denotes an arm member for transmitting the driving force for insertion and ejection operations, when the optical disc is inserted into an apparatus body from the side of a front panel (not shown) in the Y axis direction and when the optical disc is ejected from the apparatus body to the side of the front panel. Numeral 50a denotes an arm portion of the arm member 50. Numeral 50b denotes an arm support portion for rotatably supporting the arm portion 50a. Numeral 70 denotes a disc slot arm member for pulling the optical disc into the apparatus body. Numeral 80 denotes a sub lever member. Numerals 122, 123 denote lever members for operating when the optical disc is loaded or unloaded. Numeral 130 denotes a switch for turning ON or OFF the power supplied to the loading motor 40. Reference symbols g, h denote rotation fulcrums when the unit mechanism deck member 5a is vertically displaced, and P-P′ is a line through the rotation fulcrums g, h (hereinafter referred to as a fulcrum line). The feed motor 30, the lead screw member 21, and the guide members 22, 23 all constitute a movement guide mechanism portion.

On the unit mechanism deck member 5a as the second base, the lead screw member 21, the guide members 22, 23, and the feed motor 30 are mounted together with the spindle motor 2 and the optical pickup 3. The spindle motor 2 is attached to the motor fixed plate (not shown). The motor fixed plate is fixed to the back side (−Z axis direction) of the unit mechanism deck member 5a by means of screws and the like. The reference numerals 161, 162, 163 respectively denote positions at which the screws and the like are provided, namely, positions at which the motor fixed plate is fixed to the unit mechanism deck member 5a. Upon loading or unloading movement of the optical disc, the lever members 122, 123 pull the optical disc into the apparatus body to a position that the optical disc can be chucked or pull the optical disc toward the outside of the apparatus body from the position that the optical disc can be chucked. At this time the rotation driving force of the loading motor 40 is transmitted through the transmission gear array 41, so that the optical disc is displaced while maintaining a given state.

The front side (Z axis direction side) of the optical disc apparatus 100 is covered with a top cover member (not shown). It is assumed that, in the optical disc apparatus 100, the thickness dimension of the apparatus (the distance between the outer surface of the top cover member and the outer surface of the bottom case 8) is not more than 9.5×10⁻³ m.

Hereinafter the same reference numerals shown in FIG. 1 will be employed as those for denoting the same components indicated in FIG. 1.

FIG. 2 is a rear view of the unit mechanism portion in the configuration of FIG. 1.

In FIG. 2, reference numeral 15 denotes the motor fixed plate for fixing the spindle motor 2 to the unit mechanism deck member 5a. Reference symbol c denotes the rotation center of the spindle motor 2. Line C-C′ is a line through the rotation center c of the spindle motor 2 in parallel to the moving direction of the optical pickup 3. Line D-D′ is a line through the rotation center c of the spindle motor 2 in perpendicular to the moving direction of the optical pickup 3. θ₁ is an angle between a line through the position 161 and the line D-D′. θ₂ is an angle between a line through the position 162 and the line D-D′. θ₃ is an angle between a line through the position 163 and the line D-D′. Numeral 151 denotes a portion of the motor fixed plate, which is a planar portion (A portion) extending in a direction of an angle different from the angles of the three positions 161, 162, 163, namely, in a direction of an angle different from the angles θ₁, θ₂, θ₃. Here θ₄ is an angle from the position of the angle θ₃ to an end of the planar portion 151, and θ₅ is an open angle of the end portion of the planar portion 151 relative to the rotation center c of the spindle motor 2. The planar portion 151 is formed in an area ranging from θ₂+θ₄ to θ₂+θ₄+θ₅, where the angles are defined by the line D-D′. Further the unit mechanism deck member 5a has an outer edge portion having an L shape at least corresponding to the open angle θ₅. The end portion of the planar portion 151 of the motor fixed plate 15 is brought into contact with the outer edge portion, namely, the end surface of the potion extending in the −Z axis direction in the L shaped portion. Because of the contact therewith, the planar portion 151 of the motor fixed plate 15 is supported by the end surface of the L shaped portion of the unit mechanism deck member 5a. It may be possible that the planar portion 151 of the motor fixed plate 15 is brought into contact with the end surface of the unit mechanism deck member 5a in a state in which the planar portion 151 is deformed elastically. For example, the motor fixed plate 15 is formed by a silicon steel plate of a thickness of about 0.4×10⁻³ m. The position 161 is provided at an angle θ₁ of about 11 degrees with a radius of about 17.2×10⁻³ m, the position 162 at an angle θ₂ of about 65 degrees with a radius of about 17.7×10⁻³ m, and the position 163 at an angle θ₃ of about 182 degrees with a radius of about 17.5×10⁻³ m. The planar portion 151 is provided at an angle between θ₁+θ₄ and θ₂+θ₄+θ₅, ranging from about 120 to 150 degrees, with a radius of about 19.4×10⁻³ to 24.0×10⁻³ m.

In the motor fixed plate 15, of the three positions 161, 162, 163, the position 162 farthest from the optical pickup 3 and the planar portion 151 contacting the unit mechanism deck member 5a are provided opposite to each other relative to the line C-C′. Further, of the three positions 161, 162, 163, the two positions including the position 162 farthest from the optical pickup 3, 161 and 162, and the other position 163 thereof and the planar portion 151 contacting the unit mechanism deck member 5a, are provided opposite to each other relative to the line C-C′. Further, of the three positions, at least the two positions including the position 162 farthest from the optical pickup 3, 161 and 162, and the planar portion 151 contacting the unit mechanism deck member 5a, are provided on the opposite side of the optical pickup 3 relative to the line D-D′. Further of the three positions, the position 162 farthest from the optical pickup 3 is provided on the same side of the lead screw member 21 relative to the line C-C′.

Hereinafter the same reference numerals shown in FIG. 2 will be employed as those for denoting the same components indicated in FIG. 2.

FIG. 3 is a view illustrating the motor fixed plate in the unit mechanism portion of FIG. 2.

In FIG. 3, reference numeral 51a denotes the end surface of the L shaped portion of the unit mechanism deck member 5a. The planar portion 151 of the motor fixed plate 15 has a plane at the end portion thereof, which comes into contact with the end surface 51a of the unit mechanism deck member 5a. In such a state, for example, when the impact force F is applied to the plane of the chassis 4 or bottom case 8 in a vertical direction (−Z axis direction), the moment M acts on the motor fixed plate 15. However, as the motor fixed plate 15 is configured that the end portion of the planar portion 151 comes into contact with the end surface 51a of the unit mechanism deck member 5a, the motor fixed plane 15 is hardly displaced, and also the rotation center axis c of the spindle motor 2 is hardly displaced. In this way, by supporting the end portion of the planar portion 151 of the motor fixed plate 15 by the end surface 51a of the unit mechanism deck member 5a, the position and posture displacements due to the impact force F are suppressed in the spindle motor 2, so that the positional relationship between the optical disc (not shown) placed on the spindle motor 2 and the optical pickup 3 can hardly be changed. This makes it possible to avoid such problems as contact and defocusing of the objective lens 3a relative to the surface of the optical disc.

According to the above described embodiment, it is possible for the optical disc apparatus 100 to support the spindle motor 2 with an improved impact resistance by the motor fixed plate 15 of simple configuration. This makes it possible to improve the reliability of the apparatus under the configuration that an increase of the manufacturing cost is suppressed.

Incidentally, in the above described embodiment, the motor fixed plate 15 is configured that the planar portion 151 is brought into contact with the end surface 51a of the unit mechanism deck member 5a. However the present invention is not limited to such a configuration. It may also be configured that a concave portion or a convex portion is brought into contact with the unit mechanism deck member 5a.

The present invention can also be carried out in other modes than the above embodiment without departing from the spirit or principal features of the present invention. Thus the above described embodiment is merely an example of the present invention in all respects and it should not be limitedly understood. The scope of the present invention is indicated by the following claims. Further, modifications and changes belonging to the equivalent scope of the claims are all within the scope of the present invention.

What is claimed is:

1. An optical disc apparatus for recording or reproducing information by rotating and driving an optical disc by a spindle motor, and irradiating a laser beam onto the optical disc from an optical pickup, the optical disc apparatus comprising:
a first base as an apparatus base;
a unit mechanism portion including the spindle motor, the optical pickup, and a movement guide mechanism portion for moving the optical pickup in a substantially radial direction of the optical disc through rotation of a lead screw;
a second base constituting a support portion of the unit mechanism portion, being displaceable relative to the first base within a plane substantially perpendicular to a plane of the first base; and
a motor fixed plate to which the spindle motor is attached, being supported in such a way that the outside of an outer diameter of the spindle motor comes into contact with an outer edge portion of the second base,
thereby to support the motor fixed plate by the second base.

2. The optical disc apparatus according to claim 1,
wherein the motor fixed plate is fixed to the second base at a plurality of positions of different open angles relative to a rotation center of the spindle motor,
the motor fixed plate being supported in such a way that a portion in a direction of an angle, which is different from the angles of the plurality of positions, comes into contact with the second base.

3. The optical disc apparatus according to claim 1,
wherein the motor fixed plate is fixed to the second base at three positions, and
of the three positions, a position farthest from the optical pickup and a portion contacting the second base are provided opposite to each other relative to a line through a rotation center of the spindle motor in parallel to a moving direction of the optical pickup.

4. The optical disc apparatus according to claim 1,
wherein the motor fixed plate is fixed to the second base at three positions, and
of the three positions, two positions including a position farthest from the optical pickup and the other position thereof and a portion contacting the second base are provided opposite to each other relative to a line through a rotation center of the spindle motor in parallel to a moving direction of the optical pickup.

5. The optical disc apparatus according to claim 1,
wherein the motor fixed plate is fixed to the second base at three positions,
of the three positions, at least two positions including a position farthest from the optical pickup and a portion contacting the second base are provided on the opposite side of the optical pickup relative to a line through a rotation center of the spindle motor in perpendicular to a moving direction of the optical pickup.

6. The optical disc apparatus according to claim 1,
wherein the second base has an outer edge portion having an L shape, and
the motor fixed plate has a portion contacting the second base, the position being brought into contact with an end surface of the L shaped portion of the outer edge portion of the second base.

7. The optical disc apparatus according to claim 2,
wherein the motor fixed plate is fixed to the second base at three positions, and
of the three positions, a position farthest from the optical pickup is provided on the same side of the lead screw of the movement guide mechanism portion relative to a line through the rotation center of the spindle motor in parallel to the moving direction of the optical pickup.

8. The optical disc apparatus according to claim 3,
wherein the motor fixed plate is fixed to the second base at the three positions, and
of the three positions, the position farthest from the optical pickup is provided on the same side of the lead screw of the movement guide mechanism portion relative to the line through the rotation center of the spindle motor in parallel to a moving direction of the optical pickup.

9. The optical disc apparatus according to claim 4,
wherein the motor fixed plate is fixed to the second base at the three positions, and
of the three positions, the position farthest from the optical pickup is provided on the same side of the lead screw of the movement guide mechanism portion relative to the line through the rotation center of the spindle motor in parallel to a moving direction of the optical pickup.

10. The optical disc apparatus according to claim 5,
wherein the motor fixed plate is fixed to the second base at the three positions, and
of the three positions, the position farthest from the optical pickup is provided on the same side of the lead screw of the movement guide mechanism portion relative to the line through the rotation center of the spindle motor in parallel to a moving direction of the optical pickup.

11. The optical disc apparatus according to claim 6,
wherein the motor fixed plate is fixed to the second base at the three positions, and
of the three positions, the position farthest from the optical pickup is provided on the same side of the lead screw of the movement guide mechanism portion relative to the line through the rotation center of the spindle motor in parallel to the moving direction of the optical pickup.

12. The optical disc apparatus according to claim 1,
wherein the thickness of the apparatus is set to 9.5×10⁻³ m or less.

13. The optical disc apparatus according to claim 2,
wherein the thickness of the apparatus is set to 9.5×10⁻³ m or less.

14. The optical disc apparatus according to claim 3,
wherein the thickness of the apparatus is set to 9.5×10⁻³ m or less.

15. The optical disc apparatus according to claim 4,
wherein the thickness of the apparatus is set to 9.5×10⁻³ m or less.
